(19) United States
(12) Patent Application Publication
(10) Pub. No.: US 2025/0187026 A1
(43) Pub. Date: Jun. 12, 2025

(54) FLUID DISPERSION SYSTEM FOR AGRICULTURAL SPRAYERS

(71) Applicant: Air-O Fan Products Corporation, Reedley, CA (US)

(72) Inventor: Brent Davis, Reedley, CA (US)

(21) Appl. No.: 18/971,782

(22) Filed: Dec. 6, 2024

Related U.S. Application Data
(60) Provisional application No. 63/606,947, filed on Dec. 6, 2023.

(51) Int. Cl. B05B 7/00; A01C 23/00; A01M 7/00; B05B 7/14; B05B 7/24

(52) U.S. Cl. CPC B05B 7/0081; A01C 23/008; A01M 7/0014; B05B 7/14; B05B 7/2491

(57) ABSTRACT

A fluid dispersion system for agricultural sprayers may include a first axial fan within a first housing and a second axial fan within a second housing for driving air toward a dispersion chamber. The diameter of the first axial fan and housing may be less than the diameter of the second axial fan and housing such that, during operation, air is forced through the first housing and the second housing while air is also entrained around the first housing into the second housing. The configuration of the axial fans and housings creates turbulence within the dispersion chamber to amplify the dispersion of fluid dispensed within the dispersion chamber by one or more fluid nozzles. One or more air baffles may be disposed within the dispersion chamber to amplify air turbulence within the dispersion chamber.

### CROSS-REFERENCE TO RELATED APPLICATIONS

The present application claims priority to, and the benefit of, U.S. Provisional Patent Application No. 63/606,947, filed Dec. 6, 2023, which is hereby incorporated by reference in its entirety.

### FIELD OF THE INVENTION

The present invention concerns systems for dispersing fluid using an agricultural sprayer. More particularly, embodiments of the present invention concern systems for atomizing fluid using a plurality of fluid nozzles and a pair of fans for dispersing atomized fluid.

### BRIEF SUMMARY OF THE INVENTION

The present invention concerns a fluid dispersion system for an agricultural sprayer (generally referred to hereafter as “system”), as well as methods of using the same. Some embodiments of the present invention concern a system having a plurality of fluid nozzles disposed within a dispersion chamber for atomizing fluid and a pair of fans for forcing air toward the fluid nozzles and dispersing atomized fluid. The system may be incorporated into agricultural sprayers which may be mounted, or otherwise engaged, to a vehicle, such as a tractor, and may be operatively connected therewith to allow a sprayer to be controlled from the vehicle.

According to some embodiments of the present invention, a system may comprise: (i) a first axial fan and a second axial fan, each configured to force air toward a dispersion chamber; (ii) a shaft for driving each fan; and (iii) a plurality of air vanes disposed within the dispersion chamber, each having at least one nozzle for atomizing a fluid. In some embodiments, each air vane may comprise a fluid inlet through which a pressurized fluid may flow and be directed to each nozzle of the corresponding air vane. A fluid inlet, according to some embodiments, may be connected to a tank for storing the fluid. In some embodiments, each air vane may be disposed near a periphery of the dispersion chamber, with each nozzle thereof directed generally away from a center of the dispersion chamber. According to some embodiments, each pair of adjacent air vanes may be equally spaced (i.e., the distance between a pair of adjacent air vanes may be about the same for all pairs of adjacent air vanes).

In accordance with some embodiments, the first axial fan and the second axial fan may be centrally engaged with the shaft which may be longitudinally oriented from a first end to a second end of the system. In some embodiments, a rotation axis of the shaft may be generally aligned with the center of the dispersion chamber. According to some embodiments, the shaft may be engaged with one or more motors to rotate the shaft and cause the blades of the first axial fan and the second axial fan to rotate and force air toward the dispersion chamber. In some embodiments, the shaft may be power take-off (PTO) driven, or directly driven by an engine.

According to some embodiments, the system may comprise a plurality of guide vanes for maintaining air flow parallel to the shaft, where each guide vane may be centrally aligned with the shaft. A first plurality of guide vanes, in some embodiments, may be disposed adjacent to an outflow side of the first axial fan blades (i.e., the side toward the dispersion chamber). Similarly, a second plurality of guide vanes, in some embodiments, may be disposed adjacent to an outflow side of the second axial fan blades (i.e., the side toward the dispersion chamber). According to some embodiments, the second axial fan blades and the second guide vanes may each be positioned closer to the dispersion chamber, relative to the positions of each of the first axial fan blades and the first guide vanes. During operation, air flow may be directed (by the axial fan blades and guide vanes) toward the dispersion chamber where it may be redirected toward the air vanes to aid in the mixing of atomized fluid dispensed from the air vane nozzles with surrounding air and also in the dispersion of atomized fluid over a given area. In some embodiments, one or more air baffles may be disposed within the dispersion chamber for diverting air entering the dispersion chamber.

As an advantage of the present invention, and according to some embodiments, the first axial fan blades may have a diameter (i.e., the distance from an edge of a blade to a center of the rotation axis) which may be less than a diameter of the second axial fan blades. Likewise, in some embodiments, the first guide vanes may have a diameter which may be less than a diameter of the second guide vanes. In addition, and according to some embodiments, an axial fan may be disposed within a housing which, in some embodiments, may have a circumferential body and a lip circumscribing an opening of the housing. In some embodiments, a body of a housing of a first axial fan may partially extend within an opening of a housing of a second axial fan. A space between a body of a housing of a first axial fan and a body of a housing of a second axial fan, according to some embodiments, may equate approximately to the difference between the diameters of the first axial fan and second axial fan.

During operation, the configuration of the fans and housings may create a Venturi effect which causes the entrainment of surrounding air which mixes with the induced air by each fan, thereby increasing the amount of air forced into the dispersion chamber, relative to a conventional fluid dispersion system. As a result of this enhanced air flow (i.e., induced and entrained air) into the dispersion chamber, atomized fluid dispensed from the fluid nozzles may be mixed more effectively with surrounding air and dispersed over a relatively greater area compared to conventional fluid dispersion systems.

According to some embodiments, upon activation of the system, atmospheric air may be drawn into the first axial fan which, in some aspects, may be a 30″ HPR (high performance reverse) steel axial flow fan. In some embodiments, the first axial fan may be a 34″ HPR steel axial flow fan. The first axial fan may force air through the housing of the first axial fan (with guide vanes) to supercharge air delivery to the second axial fan which, in some aspects, may be a 36-inch HPR steel axial flow fan. In some embodiments, the second axial fan may be a 40″ HPR steel axial flow fan. It is to be appreciated that, in some embodiments, the first axial fan and the second axial fan may be aligned so that the blades of each fan may be picketed to cover the gap between the blades if aligned down the shaft. The second axial fan may consume forced air from the first axial fan, as well as draw atmospheric air from around the housing of the first axial fan. This creates a forced air induction Venturi effect which in turn multiplies air production through the housing of the second axial fan to positively charge the air discharge throat exit of the fan housing which, in some aspects, may have a diameter of 9 and ¾ inches. Upon the air passing through the housing of the second axial fan, according to some embodiments, there may be a series of two air baffles to divert air flow which may create more air turbulence (relative to conventional systems) before the discharge air will compress in the dispersion chamber and exit the system. Lastly, pressurized fluid may pass through one or more manifolds to a plurality of pressure hoses which, in some aspects, may each be ⅜ inch hoses each attached with an SAE (Society of Automotive Engineers) swivel fitting to a plurality of 3-port composite nylon air vanes. The introduction of fluid at the dispersion chamber combined with high air volume, extreme air turbulence, and the ability to manipulate where the discharge air and spray are directed to target a crop make the present invention advantageous over conventional systems.

According to some implementations, the axial fans of the system may be installed according to the following steps. First, the rear leading plate of the system may be removed to expose a plurality of second guide vanes within a second housing of a second axial fan. Next, the second guide vanes may be removed from the second housing of the second axial fan. Following, the shaft and bearings may be dialed to a plurality of bearing stands and tightened according to final specifications, then the shaft may be removed, leaving the bearings in place. Next, a first axial fan may be set in place, followed by setting the second axial fan in place. Following, the second guide vanes may be set back in place and loosely secured with or more fasteners (e.g., bolt(s)). Then, the shaft, with taper-locks and keys, in some embodiments, may be slid back through the bearings and axial fans. Next, the shaft may be set in place and the bearing housings may be secured to the fan shaft. Next, the taper-locks of the axial fans may be aligned and the axial fans may be set in place loosely to the guide vanes. Following, the final position of the guide vanes may be set and tightened completely. Next, the axial fans may be adjusted and set in their final position and tightened completely. Then, the rear leading-edge plate may be secured according to final specifications. Following, one or more air vanes (in some embodiments, eighteen 3-port composite nylon air vanes) may be installed into the dispersion chamber and one or connections (in some embodiments, SAE swivel connections) may be attached to one or more pressure manifold hoses which connect to the one or more air vanes. Lastly, the air baffles (which may be galvanized steel, in some embodiments) may be installed, preferably, at the bottom right and left sides of the dispersion chamber. The system may now be complete and ready for final installation to a chassis of an agricultural sprayer.

According to some embodiments of the present invention, a system for dispersing a fluid may comprise: a) a first axial fan which may have a plurality of blades and may be disposed within a first housing and centrally engaged with a shaft, where the first housing may have a first end, a second end having an outwardly protruding lip, and a circumferential body therebetween; b) a second axial fan which may have a plurality of blades and disposed within a second housing and centrally engaged with the shaft, where the second housing may have a first end, a second end having outwardly protruding lip, and a circumferential body therebetween; and c) a dispersion chamber which may comprise a central opening, a plurality of air vanes, and a plurality of fluid nozzles which may be configured to atomize the fluid, wherein each of the fluid nozzles may be engaged with one of the plurality of air vanes. In some embodiments, the first end of the second housing may be engaged to a wall of the dispersion chamber around the central opening. In some embodiments, the first end of the first housing may be positioned within the second housing between the first end of the second housing and the lip of the second housing. In some embodiments, a diameter of the body of the first housing may be less than a diameter of the body of the second housing. In some embodiments, the dispersion chamber may further comprise at least one baffle which may comprise a body and a lip. In some embodiments, the at least one baffle may comprise a first baffle and a second baffle, wherein the body of the first baffle may have a diameter greater than a diameter of the body of the second baffle. In some embodiments, the system may further comprise at least one guide vane disposed within at least one of the first housing and the second housing. In some embodiments, the at least one guide vane may comprise a first guide vane disposed within the first housing and a second guide vane disposed within the second housing, wherein the first guide vane may be positioned between the first axial fan and the second axial fan, and wherein the second guide vane may be positioned between the second axial fan and a wall of the dispersion chamber. In some embodiments, the first guide vane may have a diameter that may be less than a diameter of the second guide vane. In some embodiments, the system may further comprise a guard disposed around a portion of the first housing, where the guard may have a plurality of openings therein. In some embodiments, the plurality of blades of the first axial fan may have a diameter that is less than a diameter of the plurality of blades of the second axial fan. In some embodiments, the first axial fan may be configured to have a rotational speed that may be about the same as a rotational speed of the second axial fan. In some embodiments, at least one of the first axial fan and the second axial fan may be engaged to the shaft through a gear. In some embodiments, the system may further comprise an engine engaged with the shaft. In some embodiments, the system may further comprise a power take-off, wherein the shaft may be engaged to the engine through the power take-off. In some embodiments, the system may further comprise a tank for storing the fluid to be dispersed and a fluid line engaged to the tank and each the plurality of fluid nozzles.

According to some embodiments of the present invention, a system for dispersing a fluid, may comprise: a) an engine engaged with a shaft; b) a tank for storing the fluid to be dispersed; c) a dispersion chamber which may comprise a wall with a central opening, a plurality of air vanes, at least one baffle, and a plurality of fluid nozzles for atomizing the fluid, wherein each fluid nozzle may be engaged to the tank through a fluid line; d) a first axial fan which may comprise a plurality of blades and may be centrally engaged with the shaft, a first guide vane, and a first housing; and c) a second axial fan which may comprise a plurality of blades and may be centrally engaged with the shaft, a second guide vane, and a second housing, wherein the second axial fan may be positioned between the first axial fan and the wall of the dispersion chamber; wherein the second housing may be engaged with the wall of the dispersion chamber around the central opening, wherein a diameter of the plurality of blades of the first axial fan may be smaller than a diameter of the plurality of blades of the second fan, wherein a diameter of the first housing may be smaller than a diameter of the second housing, wherein the first guide vane may be positioned between the first axial fan and the second axial fan, and wherein the second guide vane may be positioned between the second axial fan and the wall of the dispersion chamber. In some embodiments, the second axial fan may be positioned between the first axial fan and the wall of the dispersion chamber. In some embodiments, the first guide vane may be positioned between the first axial fan and the second axial fan, and the second guide vane may be positioned between the second axial fan and the wall of the dispersion chamber.

According to some embodiments of the present invention, a method of dispersing a fluid may comprise the steps of: a) engaging a system to a tractor, where the system may comprise: 1) a dispersion chamber with a wall which may have a central opening and plurality of fluid nozzles; 2) a first axial fan which may be disposed in a first housing, where the first housing may have a first end and a second end; and 3) a second axial fan which may be disposed in a second housing, where the second housing may have a first end and a second end, wherein the second end may be engaged to the wall of the dispersion chamber around the central opening, wherein the second housing may surround a portion of the second end of the first housing; b) rotating the first axial fan to direct airflow towards the second axial fan; c) rotating the second axial fan to direct the airflow through the central opening in the wall of the dispersion chamber; and d) ejecting the fluid through the plurality of fluid nozzles to atomize the fluid in the dispersion chamber. In some embodiments, the system may further comprise a first air vane and the step of directing the airflow towards the second axial fan may comprise the step of directing the airflow through the first air vane. In some embodiments, the system may further comprise a second air vane and the step of directing the airflow through the central opening in the wall of the dispersion chamber may comprise the step of directing the airflow through the second air vane. In some embodiments, the dispersion chamber may further comprise at least one baffle and the method may further comprise the step of: c) directing the airflow through the at least one baffle towards the atomized fluid.

### BRIEF DESCRIPTION OF THE FIGURES

FIG. 1 is a top perspective view diagram illustrating a fluid dispersion system, in accordance with some embodiments of the present invention.

FIG. 2 is a top perspective view diagram illustrating components of the fluid dispersion system of FIG. 1, in accordance with some embodiments of the present invention.

FIG. 3 is a side view diagram illustrating components of the fluid dispersion system of FIG. 1, in accordance with some embodiments of the present invention.

FIG. 4 is a top perspective view diagram illustrating components of the fluid dispersion system of FIG. 1, in accordance with some embodiments of the present invention.

FIG. 5 is a front view diagram illustrating components of the fluid dispersion system of FIG. 1, in accordance with some embodiments of the present invention.

FIG. 6 is a side view diagram illustrating components of the fluid dispersion system of FIG. 1, in accordance with some embodiments of the present invention.

FIG. 7 is a front view diagram illustrating components of the fluid dispersion system of FIG. 1, in accordance with some embodiments of the present invention.

FIG. 8 is a side perspective view diagram illustrating components of the fluid dispersion system of FIG. 1, in accordance with some embodiments of the present invention.

FIG. 9 is a side perspective view diagram illustrating components of the fluid dispersion system of FIG. 1, in accordance with some embodiments of the present invention.

FIG. 10 is a bottom view diagram illustrating components of the fluid dispersion system of FIG. 1, in accordance with some embodiments of the present invention.

### DETAILED DESCRIPTION OF THE INVENTION

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention, including any length, angles, or other measurements provided. Rather the invention, as defined by the claims, may cover alternatives, modifications, and/or equivalents of the exemplary embodiments.

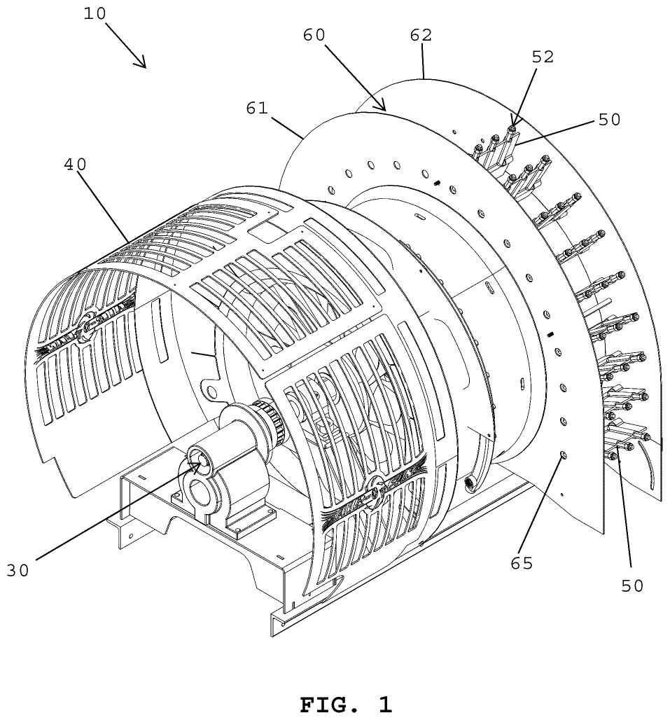

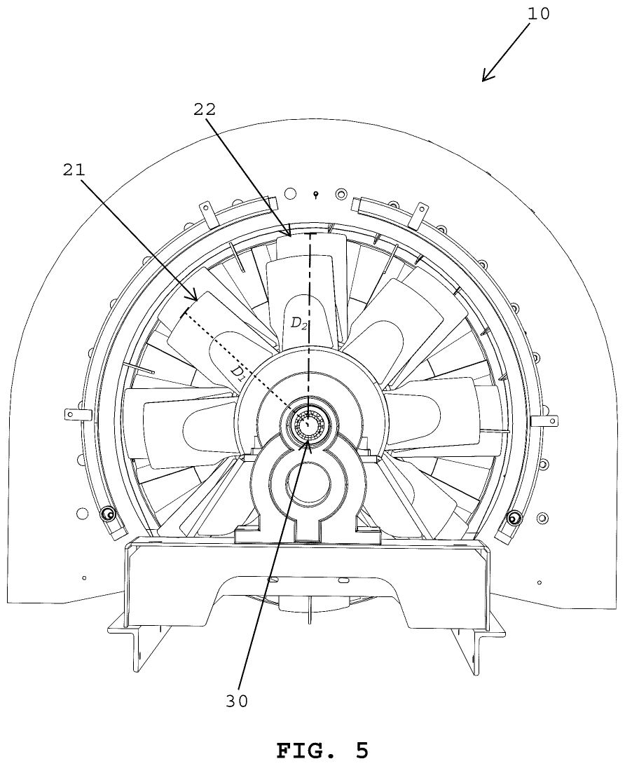

According to some embodiments of the present invention, a fluid dispersion system may generally comprise a fan system and a fluid dispensing system, where the fan system is configured to force air generally in the direction of a plurality of nozzles configured to atomize a fluid. In some embodiments, the fan system may draw in air from a first side of the system and direct the air to a second side of the system. For example, and with reference, generally, to FIGS. 1-5, a system 10 may comprise a first axial fan and a second axial fan which may be engaged with a shaft 30 configured to rotate a plurality of blades 21 and 22 of the first axial fan and the second axial fan, respectively. In some embodiments, an axial fan may be engaged to a shaft by means of one or more gears. Each axial fan may have a rotating portion comprising a body with the fan blades engaged thereto to cause the movement of air. In some embodiments, the size of the blades of the first axial fan may be the same or different relative to the blades of the second axial fan. Likewise, the number of blades of the first axial fan may be the same or different than the number of blades of the second axial fan. In some preferred embodiments, the first axial fan and the second axial fan may have the same number of blades, but the blades of the first axial fan may be shorter than the blades of the second axial fan. According to some embodiments, the blades of the first axial fan may be aligned with the blades of the second axial fan (when viewed in the longitudinal direction of the shaft, such as the view of FIG. 5). In other embodiments, the blades of the first axial fan may be offset from the blades of the second axial fan. In some embodiments, a blade may comprise one or more non-planar surfaces.

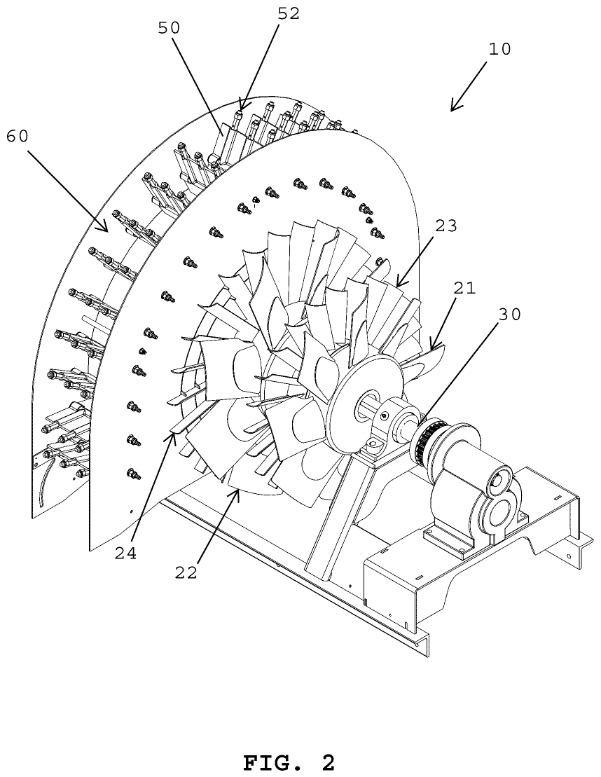

In some embodiments, an axial fan may comprise one or more guide vanes. For example, and with reference to FIG. 2, the first axial fan may comprise a plurality of guide vanes 23 adjacent to first axial fan blades 21 and the second axial fan may comprise a plurality of guide vanes 24 adjacent to second axial fan blades 22, where each guide vane may be centrally aligned with shaft 30. In some implementations, guide vanes 23 and 24 may stabilize air flow during operation by maintaining the direction of flow about parallel to shaft 30.

According to some embodiments, and with reference to FIG. 1, for example, partially enclosing an area adjacent to first axial fan 21 may be a guard 40 having a plurality of openings for allowing air to flow therethrough. When in operation, the first axial fan and the second axial fan may cause air to enter through guard 40 and be drawn toward an opposite side of system 10 toward the fluid dispensing system.

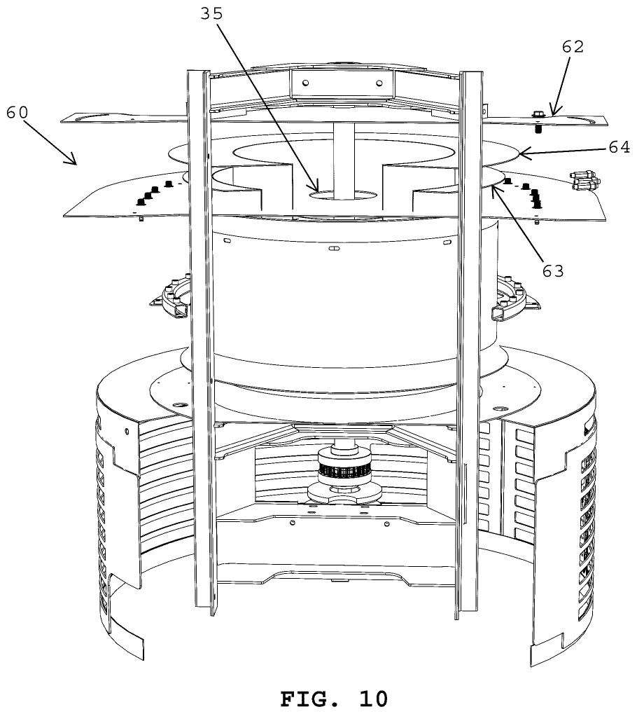

According to some embodiments, a fluid dispensing system may comprise one or more air vanes having one or more nozzles engaged therewith. In some embodiments, a nozzle may comprise a single tip or multiple tips (i.e., a nozzle which dispenses fluid out of multiple tips from a single inlet fluid stream). For example, and with further reference to FIGS. 1 and 2, system 10 may comprise a plurality of air vanes 50, each having a plurality of nozzles 52 engaged therewith, which may be disposed within a dispersion chamber 60 positioned at an opposite side to guard 40. Dispersion chamber 60 may comprise a first wall 61 and a second wall 62, where first wall 61 may comprise a central opening 35 (see, e.g., FIG. 10) to allow air to flow into dispersion chamber 60. In some embodiments, one or more of the walls of a dispersion chamber may be removable and replaceable. For example, first wall 61 and second wall 62 may be removable to allow access to the second axial fan which may allow access thereto without the disassembly of the first axial fan. As further illustrated in FIGS. 1 and 2, for example, air vanes 50 may be disposed near a periphery of dispersion chamber 60 with the spacing being about constant between each pair of adjacent air vanes. Nozzles 52 may be directed generally away from a center of dispersion chamber 60 and about perpendicular to the rotation of shaft 30.

In some embodiments, a wall of a dispersion chamber may have a fluid inlet which may be aligned with an opening in an air vane to allow a pressurized fluid to flow through the air vane opening and into a nozzle. For example, and with further reference to FIG. 1, system 10 may comprise a plurality of fluid inlets 65 formed in first wall 61 which may be aligned with openings in air vanes 50 (not illustrated) which may be configured to receive a fluid. In some embodiments, a fluid line may be connected to a fluid inlet to transport a fluid thereto. According to some embodiments, a fluid line may be connected to a tank containing fluid. In some embodiments, the fluid may comprise an aqueous solution comprising a fertilizer. In some embodiments, the fluid may comprise an aqueous solution comprising a pesticide or fungicide. It is to be appreciated that some embodiments of the present invention are particularly well suited for agricultural purposes, and in such embodiments, the fluid may comprise a conventional agricultural agent with beneficial horticultural purposes.

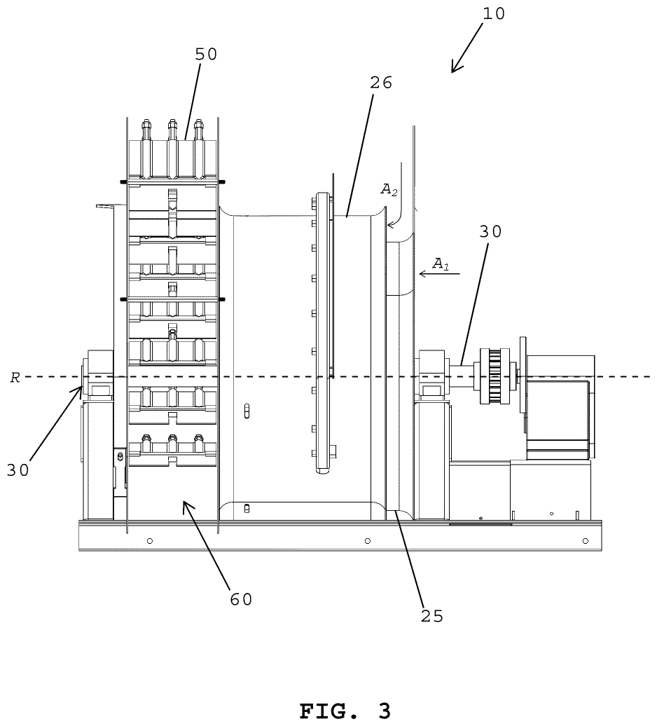

In some embodiments, a second axial fan may be positioned such that a first side thereof is adjacent to a dispersion chamber and a second side thereof is adjacent to a first axial fan. For example, and with further reference to FIG. 2, the outflow side of the second axial fan may be disposed adjacent to dispersion chamber 60 (with guide vanes 24 therebetween) and the inflow side of the second axial fan may be disposed adjacent to the first axial fan (with guide vanes 22 therebetween). With reference to FIGS. 2 and 3, the first axial fan and the second axial fan may be centrally engaged with shaft 30 which may extend from an inflow side of system 10 (the side with guard 40, illustrated in FIG. 1) and through dispersion chamber 60 (with an end of shaft 30 being anchored adjacent to second wall 62). As illustrated in FIG. 3, a rotation axis R of shaft 30 may be aligned near a center of dispersion chamber 60. Shaft 30 may be engaged with and driven by one or more motors (not illustrated) to cause the first axial fan and the second axial fan to drive air toward dispersion chamber 60.

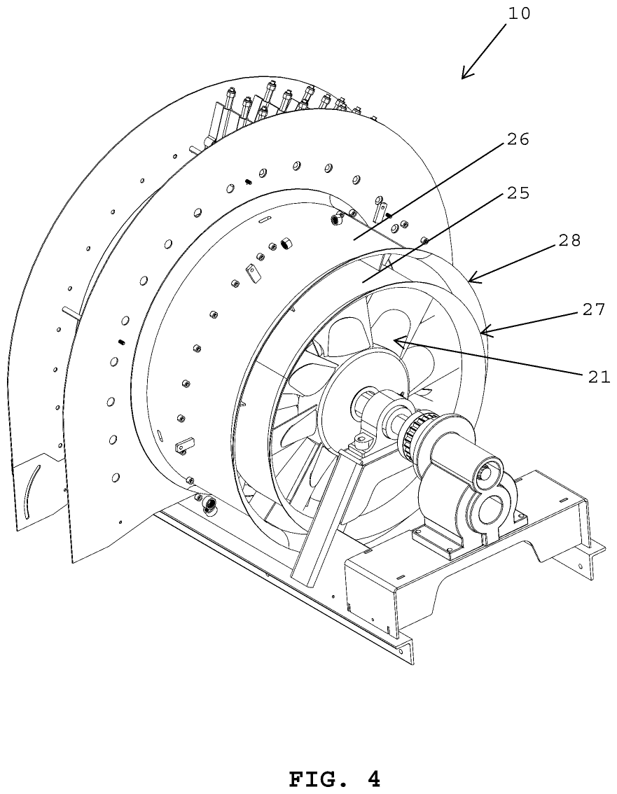

According to some embodiments, a first axial fan and/or a second axial fan may be disposed within a housing. For example, and with reference to FIGS. 3 and 4, the first axial fan may be disposed within a first housing 25 and the second axial fan (not illustrated) may be disposed within an a second housing 26. In some embodiments, a housing may have a body and a lip circumscribing the opening of the body. For example, first housing 25 may have a lip 27 and second housing 26 may have a lip 28, where each lip may be rounded outwardly (i.e., away from the openings of the housings). First housing 25 may partially extend within the opening of second housing 26, with a space formed therebetween.

According to some embodiments, a first axial fan and a second axial fan may be similarly shaped and/or sized. In other embodiments, a first axial fan may be differently shaped and/or sized relative to a second axial fan. For example, and with reference to FIG. 5, first axial fan blades 21 may have a diameter D₁ (small dashed line) which may be less than that of a diameter D₂ (small and large dashed line) of second axial fan blades 22. Therefore, since the first axial fan and the second axial fan rotate at the same speed (since they are both engaged with shaft 30), the tangential speed of the second axial fan may be greater than that of the first axial fan (since D₂ is greater than D₁). However, it is to be appreciated that, in some embodiments, the axial fans may be engaged with different shafts to rotate at different speeds and/or may have different diameters. For example, and without limitation, the first axial fan may be engaged directly with a shaft and the second axial fan may be engaged to the shaft via a transmission or gearing mechanism.

In some embodiments, a diameter of an opening of a housing may be slightly greater than that of an axial fan housed therein. As further illustrated in FIG. 4, the width of the space between first housing 25 and second housing 26 may equate approximately to the difference between diameter D₁ of first axial fan blades 21 and diameter D₂ of second axial fan blades 22 (illustrated in FIG. 5). Advantageously, the configurations of the first axial fan, first housing 25, the second axial fan, and second housing 26 may create a Venturi effect during operation, causing entrainment of surrounding air which mixes with the induced airflow, which amplifies the amount of air that is forced into dispersion chamber 60 and, therefore, amplifies the mixing and dispersion of atomized fluid. For example, and referring briefly back to FIG. 3, during operation, air may be drawn toward the first axial fan (not illustrated), indicated by A₁, by the rotation of first axial fan blades 21 and second axial fan blades 22 (not illustrated). At the same time, air may be entrained into housing 26, as indicated by A₂.

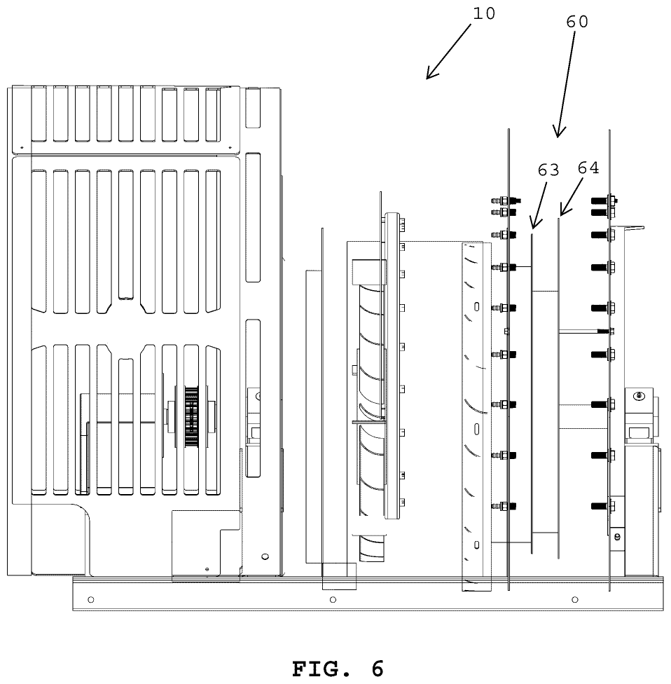

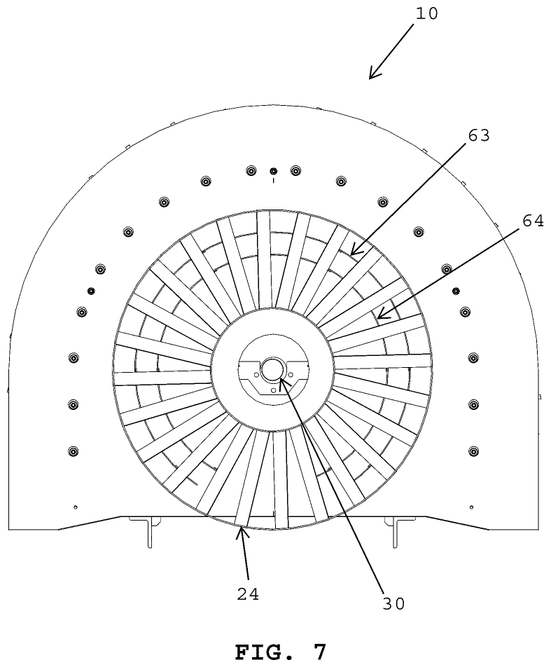

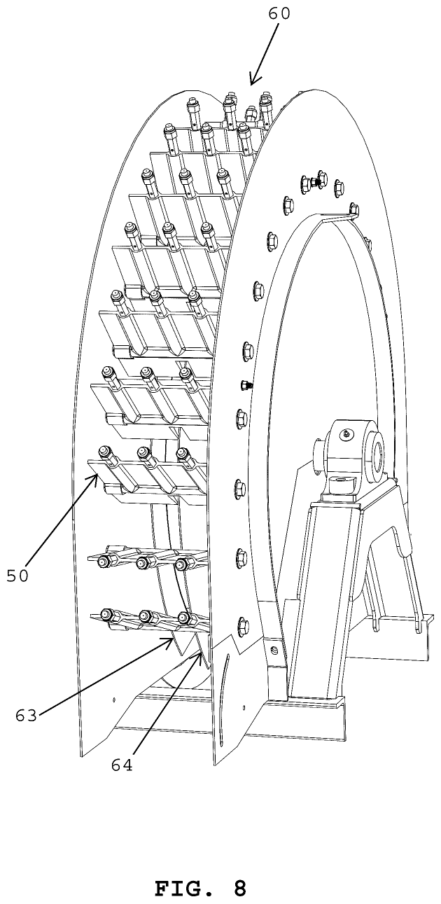

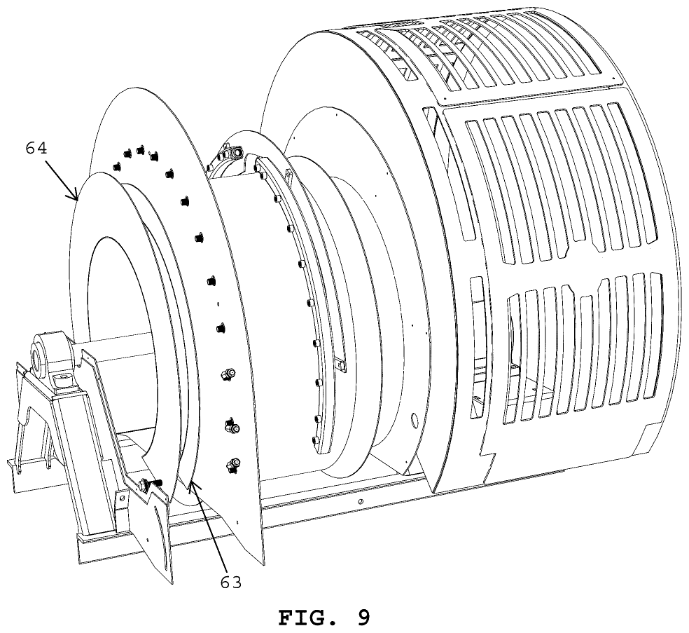

According to some embodiments of the present invention, a fluid dispersion system may comprise one or more air baffles for diverting air outflow. For example, and with reference, generally, to FIGS. 6-10, system 10 may comprise a semi-circular first baffle 63 and a semi-circular second baffle 64, each of which may be partially disposed within dispersion chamber 60 and having a center which may be about aligned with shaft 30. In some embodiments, two or more baffles may be configured to have different shapes and/or sizes. For example, each baffle may have a body which extends longitudinally and a lip which extends about perpendicular thereto, as more clearly illustrated in FIGS. 6, 9, and 10. However, and as more clearly illustrated in FIGS. 7 and 10, first baffle 63 may have a larger diameter than that of second baffle 64, but the lip of second baffle 64 may extend further from the body thereof relative to the distance that the lip of first baffle 63 extends from the body thereof.

It is to be appreciated that an air baffle, as well as the walls of a dispersion chamber, may direct air flow entering the dispersion chamber from the fan system, with the shape and placement of the baffle affecting how the outflow air is distributed. For example, and with reference to FIG. 10, as air enters dispersion chamber 60 through an outlet 35, some of the air may be forced underneath the lip of first baffle 63 (with the underside of the lip facing toward the bottom of FIG. 10), between first baffle 63 and second baffle 64, and over the top of the lip of second baffle 64, with the air eventually being deflected away from outlet 35 and toward the periphery of dispersion chamber 60 where air vanes 50 (not illustrated in FIG. 10) are positioned (and, therefore, toward any fluid being atomized by air vanes 50).

According to some implementations of the present invention, during operation, actuation of the first axial fan and the second axial fan may draw air in from the inflow side (i.e., the side opposite to dispersion chamber 60), forcing air through guard 40 (if attached) and into housing 25. While air is drawn into housing 25, air is also entrained into housing 26 toward second axial fan 22, bypassing the first axial fan blades 21 and guide vanes 23, but amplifying the air flow exiting the first axial fan. After air passes through second axial fan blades 22 and guide vanes 24, the air enters dispersion chamber 60 and interacts with first baffle 63 and second baffle 64. Within dispersion chamber 60, first baffle 63 and second baffle 64 may redirect air flow toward air vanes 50 (not illustrated in FIG. 6) and generally away from rotation axis R. When air is flowing through dispersion chamber 60 during the activation of nozzles 52 of air vanes 50, atomized fluid is mixed with the air and dispersed generally in the direction of the air flow (i.e., away from rotation axis R) to be applied over a given area.

In some implementations of the present invention, a fan system of a fluid dispersion system may be assembled, generally, according to the following steps which, in some implementations, may not be performed in the order presented and, in some implementations, one or more of the following steps may not be performed. First, a rear plate of a first fan housing may be removed. Next, a plurality of first guide vanes may be removed from the first fan housing. Following, a fan shaft may be removed from a fan system. Then, a second axial fan with a plurality of second guide vanes may be set in place within a second housing, with the second guide vanes disposed on an outflow side of the second axial fan. Next, a first axial fan and the first guide vanes may be set in place within the first fan housing, with the first guide vanes disposed on an outflow side of the first axial fan. Following, the shaft may be slid through the center of each of the axial fans and the guide vanes and then secured. Then, the first axial fan and the second axial fan, along with the first guide vanes and the second guide vanes, may be secured within the first housing and the second housing, respectively. Next, the rear plate may be secured to the first fan housing. Following, one or more air vanes may be installed within a dispersion chamber of the fluid dispensing system. Then, one or more air baffles may be installed within the dispersion chamber.

In some implementations of the present invention, a fan system of a fluid dispersion system may be disassembled according to the following steps which, in some implementations, may not be performed in the order presented and, in some implementations, one or more of the following steps may not be performed. First, one or more air baffles may be removed within the dispersion chamber (or the air baffles may be removed with the rear plate of the first fan housing). Next, one or more air vanes may be removed from within a dispersion chamber of the fluid dispensing system. Following, a rear plate or wall may be unsecured from a first fan housing and removed. Then, a first axial fan and a second axial fan, along with a plurality of first guide vanes and second guide vanes, may be unsecured from within the first fan housing and a second housing, respectively. Next, a fan shaft may be unsecured and removed. Following, the first axial fan and first guide vanes may be removed from the first fan housing. Then, the second axial fan and second guide vanes may be removed from the second housing.

It is to be understood that variations, modifications, and permutations of embodiments of the present invention may be made without departing from the scope thereof. It is also to be understood that the present invention is not limited by the specific embodiments, descriptions, or illustrations or combinations of either components or steps disclosed herein. Thus, although reference has been made to the accompanying figures, it is to be appreciated that these figures are exemplary and are not meant to limit the scope of the invention.

What is claimed is:

1. A system for dispersing a fluid comprising:
a) a first axial fan having a plurality of blades and disposed within a first housing and centrally engaged with a shaft, said first housing having a first end, a second end comprising an outwardly protruding lip, and a circumferential body therebetween;
b) a second axial fan having a plurality of blades and disposed within a second housing and centrally engaged with said shaft, said second housing having a first end, a second end comprising an outwardly protruding lip, and a circumferential body therebetween; and
c) a dispersion chamber comprising a central opening, a plurality of air vanes, and a plurality of fluid nozzles configured to atomize said fluid, wherein each of said fluid nozzles is engaged with one of said plurality of air vanes.

2. The system of claim 1, wherein said first end of said second housing is engaged to a wall of said dispersion chamber around said central opening.

3. The system of claim 2, wherein said first end of said first housing is positioned within said second housing between said first end of said second housing and said lip of said second housing.

4. The system of claim 3, wherein a diameter of said body of said first housing is less than a diameter of said body of said second housing.

5. The system of claim 1, wherein said dispersion chamber further comprises at least one baffle, said at least one baffle comprising a body and a lip.

6. The system of claim 5, wherein said at least one baffle comprises a first baffle and a second baffle, wherein said body of said first baffle has a diameter greater than a diameter of said body of said second baffle.

7. The system of claim 1, further comprising at least one guide vane disposed within at least one of said first housing and said second housing.

8. The system of claim 7, wherein said at least one guide vane comprises a first guide vane disposed within said first housing and a second guide vane disposed within said second housing, wherein said first guide vane is positioned between said first axial fan and said second axial fan, and wherein said second guide vane is positioned between said second axial fan and a wall of said dispersion chamber.

9. The system of claim 8, wherein said first guide vane has a diameter that is less than a diameter of said second guide vane.

10. The system of claim 1, further comprising a guard disposed around a portion of said first housing, said guard having a plurality of openings therein.

11. The system of claim 1, wherein said plurality of blades of said first axial fan have a diameter that is less than a diameter of said plurality of blades of said second axial fan.

12. The system of claim 1, wherein said first axial fan is configured to have a rotational speed that is about the same as a rotational speed of said second axial fan.

13. The system of claim 1, wherein at least one of said first axial fan and said second axial fan are engaged to said shaft through a gear.

14. The system of claim 1, further comprising an engine engaged with said shaft.

15. The system of claim 14, further comprising a power take-off, wherein said shaft is engaged to said engine through said power take-off.

16. A system for dispersing a fluid, comprising:
a) an engine engaged with a shaft;
b) a tank for storing said fluid to be dispersed;
c) a dispersion chamber comprising a wall with a central opening, a plurality of air vanes, at least one baffle, and a plurality of fluid nozzles for atomizing said fluid, wherein each fluid nozzle is engaged to said tank through a fluid line;
d) a first axial fan comprising a plurality of blades and centrally engaged with said shaft, a first guide vane, and a first housing; and
e) a second axial fan comprising a plurality of blades and centrally engaged with said shaft, a second guide vane, and a second housing, wherein said second axial fan is positioned between said first axial fan and said wall of said dispersion chamber;
wherein said second housing is engaged with said wall of said dispersion chamber around said central opening,
wherein a diameter of said plurality of blades of said first axial fan is smaller than a diameter of said plurality of blades of said second fan,
wherein a diameter of said first housing is smaller than a diameter of said second housing,
wherein said first guide vane is positioned between said first axial fan and said second axial fan, and
wherein said second guide vane is positioned between said second axial fan and said wall of said dispersion chamber.

17. A method of dispersing a fluid comprising the steps of:
a) engaging a system to a tractor, said system comprising:
1) a dispersion chamber with a wall having a central opening and plurality of fluid nozzles;
2) a first axial fan disposed in a first housing, said first housing having a first end and a second end; and
3) a second axial fan disposed in a second housing, said second housing having a first end and a second end, said second end engaged to said wall of said dispersion chamber around said central opening, wherein said second housing surrounds a portion of said second end of said first housing;
b) rotating said first axial fan to direct airflow towards said second axial fan;
c) rotating said second axial fan to direct said airflow through said central opening in said wall of said dispersion chamber; and
d) ejecting said fluid through said plurality of fluid nozzles to atomize said fluid in said dispersion chamber.

18. The method of claim 17, wherein said system further comprises a first air vane and wherein said step of directing said airflow towards said second axial fan comprises the step of directing said airflow through said first air vane.

19. The method of claim 18, wherein said system further comprises a second air vane and wherein said step of directing said airflow through said central opening in said wall of said dispersion chamber comprises the step of directing said airflow through said second air vane.

20. The method of claim 17, wherein said dispersion chamber further comprises at least one baffle and wherein said method further comprising the step of:
e) directing said airflow through said at least one baffle towards said atomized fluid.
